(19) United States
(12) Patent Application Publication
(10) Pub. No.: US 2006/0269089 A1
(43) Pub. Date: Nov. 30, 2006

(54) Microphone shield

(76) Inventor: David Van Gieson, Ventura, CA (US)

Correspondence Address: English & Associates, Attorneys at Law;County Square Professional Offices, Suite 101, 674 County Square Drive, Ventura, CA, 93003, US

(21) Appl. No.: 11/136,289

(22) Filed: May 24, 2005

(51) Int. Cl. H04R 9/08

(52) U.S. Cl. 381/361

(57) ABSTRACT

A microphone shield that has a body of generally conical or semi-spherical configuration with its large end being open, and its small end having a central opening adapted to receive the base of a microphone. The interior surface of the shield is lined with a sound absorbing material, while the outer surface is covered with a sound reflecting material.

### FIELD OF THE INVENTION

This invention relates to a sound system apparatus and the method of using it, and particularly in live musical performances or the recording of music.

### BACKGROUND OF THE INVENTION

During musical performances, whether for a live audience or for recording purposes, there will often be two or more sources of the sound that need to be reproduced. For example, there may be two or more singers, or two or more instruments, or both. Separate microphones are often used for the separate sound sources. This, however, often involves the problem of “bleed”—that is, a microphone intended to pick up only the sound from only one particular source may also, to some extent, pick up sound from the other sources as well. There may also be “bleed” from extraneous sources.

During live performances the editing and mixing of the separate sound inputs must be done in real time. When a recording is done, the separate inputs may be separately edited, involving perhaps several passes through the same information, before the various inputs are then combined in mixing process. Although there is some difference in the procedure between live performance and recording, the fundamental fact remains that it is often desirable to have each microphone pick up only a single input of sound from one particular source, free and clear of the other sources as well as from extraneous influences.

It has been known in the prior art to employ a shield for a microphone, to prevent or limit the “bleed” of sound from sources other than the desired input. But the prior technology has not fully address the problem.

Various sound barrier technology is well known in the art. Drake et al. in U.S. Pat. No. 6,827,179 teaches of a general sound barrier system for use in dampening traffic noise to protected areas, such as residential zones. A face skin panel faces the source of the sound and a back skin panel faces the filler material that absorbs the sound and protects the designated area. Similarly, Shima et al. in U.S. Pat. No. 6,006,858 discloses a noise control apparatus designed to protect residential areas from roadway noise by adapting an apparatus for installation on top of a straight upright sound barrier such as the invention described by Drake et al. The Shima invention adds additional sound barrier qualities.

Inventions designed to avoid unwanted sounds during the use of a microphone are also known in the art. Soutar et al. in U.S. Pat. No. 6,771,788 teaches of a shielded microphone that contains an impervious elastic membrane that is stretched over and covering a microphone on all sides. This relatively complex invention is designed to exclude frequency ranges from reaching the microphone that are found from environmental effects such as wind and rain. Rodemer in U.S. Pat. No. 6,643,380 teaches of a shielded microphone module and preamplifier for installation in a helmet or similar device designed for hands-free communication systems. Both the Soutar and Rodemer inventions offer methods of shielded unwanted noise from a microphone, but both are limited in their ability to isolate sounds during the performance and recording of music. Additionally, both the Rodemer and Soutar inventions are more complex than necessary to achieve the desired outcome of the instant invention.

### SUMMARY OF THE INVENTION

According to the present invention a microphone shield is provided that is particularly adapted for picking up sound from a sound source having a flat vibratory surface, such as the forward surface of a kick drum, or the baffle of a loud speaker. The shield is effective not only for precluding “bleed” from other sound sources, but also for preventing the pickup of distorted versions of the chosen input.

Thus according to the presently preferred form of the invention a microphone shield is provided, having a body that is essentially in the shape of a half-sphere or a cone. The body of the shield is open at its large end, and has a central opening in its small end. On its interior wall the shield has a surface of a sound reflecting material. Further, when a conventional microphone is inserted into the shield with the microphone base occupying the central hole in the small end of the shield and the head of the microphone projecting into the shield, the relative dimensions are such that there is a circumferential space between the microphone head and the interior wall surface of the shield. Furthermore, the microphone head is then recessed or inset relative to the rim of the shield that surrounds the opening at the large end of the shield.

### OBJECTS OF THE INVENTION

The principal object of the invention is to provide a method of precluding the introduction of unwanted sound sources into a microphone during sound production.

It is yet another object of the invention to prevent the pickup of distorted version of the chosen sound input into a microphone during sound production.

Numerous other advantages and features of and various means for practicing the invention will become apparent from the detailed description of the preferred embodiment of the invention, from the claims, and from the accompanying drawings, in which like numerals are used to designate like parts shown in different figures.

### BRIEF DESCRIPTION OF THE DRAWINGS

The novel features of this invention will be best understood from the accompanying Figures, taken in conjunction with the accompanying description, in which similar characters refer to similar parts, and in which:

FIG. 1, partly in schematic form, is a cross-sectional view of the presently preferred form of microphone shield in accordance with the invention as it is applied to the flat vibratory surface of a sound source;

FIG. 2 is a perspective view showing application of the microphone shield and its accompanying microphone to the front baffle of a loudspeaker; and

FIG. 3 is a perspective view showing application of the microphone shield and its accompanying microphone to the front wall surface of a kick drum.

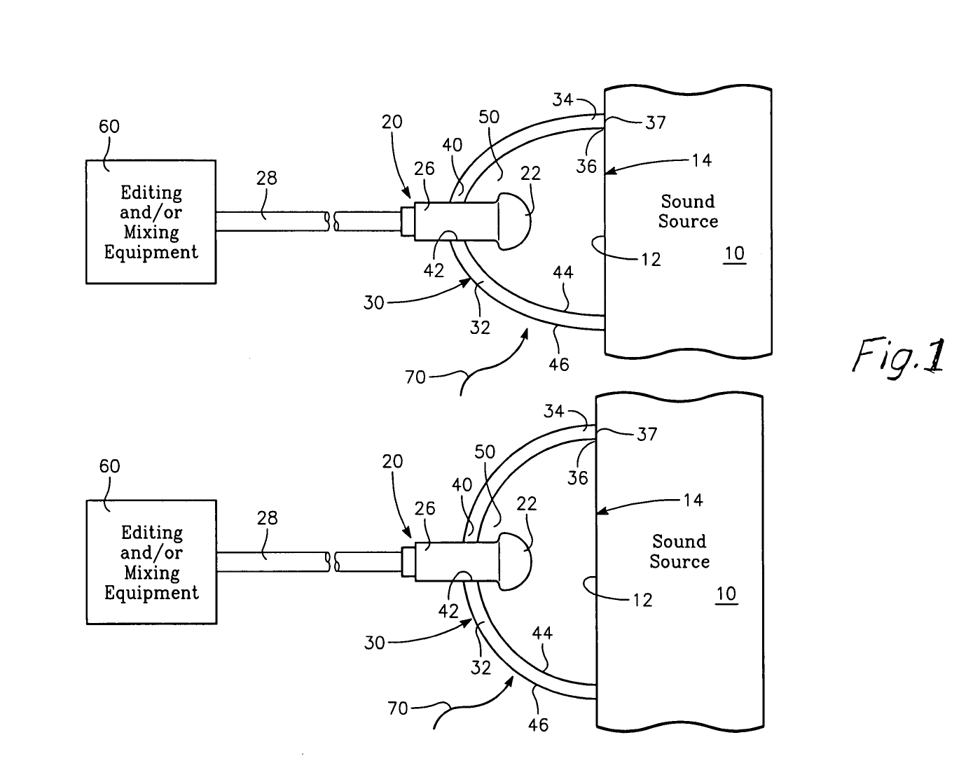

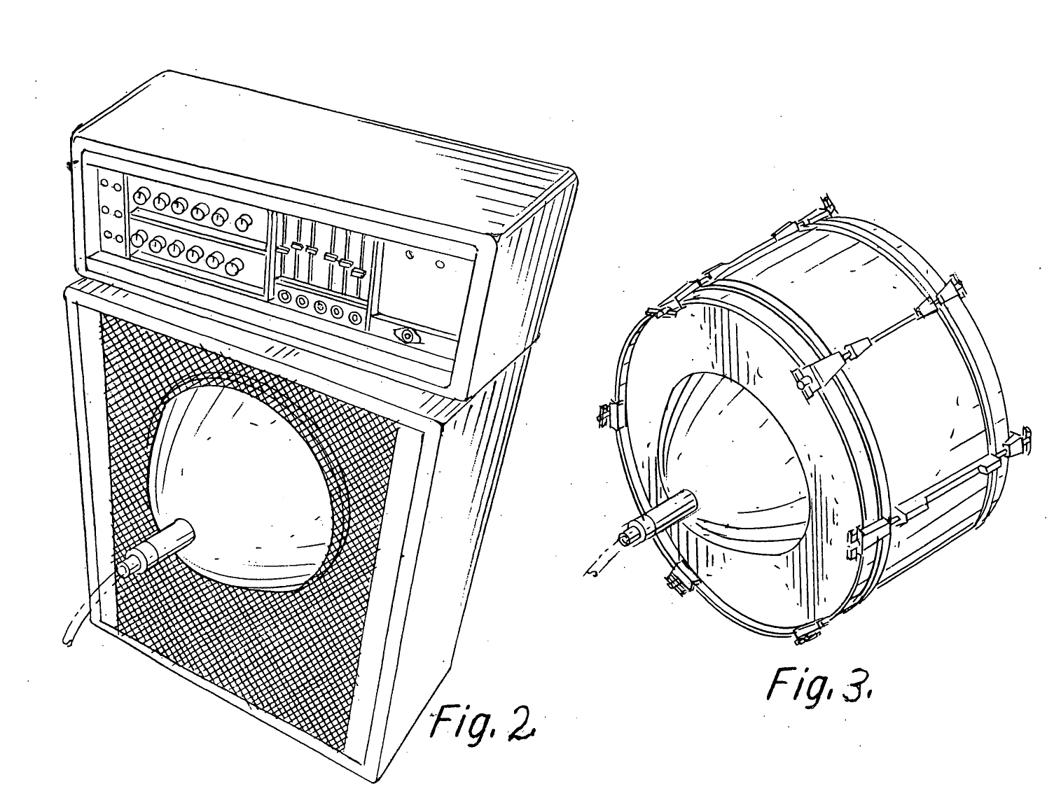

It will be noted that FIG. 1 is taken in part as a cross-section of either FIG. 2 or FIG. 3.

### DETAILED DESCRIPTION OF AN ENABLING AND PREFERRED EMBODIMENT

Referring now to the drawings, and particularly FIG. 1, a sound source 10 has a flat vibratory surface 12 through which an input signal 14 is transmitted. A microphone assembly 20 includes a microphone head 22 supported on a microphone base 26 which is in turn connected to a microphone cord 28. Utilizing microphone shield 30, the sound from input signal 14 is rather closely directed into the microphone head 22.

Microphone shield 30 has a body 32 which is of a generally semi-spherical or conical configuration. It has a large end 34 which is entirely open at 36. It small end 40 has a central opening 42 formed therein. The microphone assembly is inserted into the shield such that the microphone base 26 occupies the opening 42, while microphone head 22 is inside the shield and separated from its walls.

The interior wall surface 44 of the shield 30 is made of a sound absorbing material, preferably a foam plastic. The exterior wall surface 46 is covered with a sound reflecting material, such as rubber. The circumferential space between the microphone head 22 and the interior wall surface 44 is designated as 50. At its large end 34 the shield has a rim 37 which surrounds the opening 36. The microphone head 22 is inset somewhat, in a direction along the axis of opening 42 and base 26, from the rim 37.

As shown in FIG. 1, the shield 30 is preferably positioned so that the rim 37 on its large end is in abutting engagement with the flat vibratory surface 12 of the sound source 10. This ensures that the sound picked up by the microphone becomes an output signal which is then passed through the cord 28 to an editing and mixing circuit apparatus 60.

Also shown in FIG. 1 is an arrow 70, representing sound signals from extraneous sources, which are not picked up by the microphone head but are reflected because of the protection afforded by the shield.

An important fact is that sound from an input signal 14 as it enters the shield 30 is not distorted before being picked up by the microphone head 22, because of the circumferential space 50 around the microphone head 22, and the fact that the interior wall surface 44 is covered with a sound absorbing material.

FIG. 2 shows the microphone shield in abutting engagement with the flat vibratory surface of a loudspeaker, while FIG. 3 shows it in abutting engagement with the flat vibratory surface of a kick drum.

In a modified form of the invention, it may not be necessary for the rim 37 of the shield to be in an abutting engagement with the vibratory surface 12 of the sound source, so long as it is rather close to it, preferably in a substantially parallel relationship.

While the particular invention, as herein shown and disclosed in detail, is fully capable of obtaining the objects and providing the advantages above stated, it is to be understood that the presently preferred embodiments are merely illustrative of the invention and no limitations are intended therefor.

I claim:

1. A microphone shield, comprising:
a body of generally conical shape, having a small end opening and a large end opening;
said body being lined with sound absorbing material on the internal surface of said body;
said body being lined with sound reflecting material on the external surface of said body;
wherein, upon inserting a microphone in said small end of said conical body, and placing said large end of said conical body flatly against a sound source, the sound that emanates from the sound source and enters said conical body via said large end reaches the microphone free of internal sound reflections, and free of external sound incident to said external surface of said conical body.

2. Sound receiving apparatus, comprising: in combination with said microphone shield of claim 1, and a microphone inserted into said small end of said conical body, and a flat vibratory surface against which said large end of said conical body rests in abutting engagement.

3. Sound receiving apparatus, comprising: the combination of a sound source having a flat vibratory surface through which a desired sound is emitted, a microphone for receiving the desired sound, and a microphone shield for preventing the microphone from receiving both undesired exterior sounds and distorted versions of the desired sound, the shield comprising a body of generally hemispherical configuration having As large open base in abutting engagement with the flat vibratory surface of the sound source, and having a central opening in the distal, apex end of said hemisphere body, whereby said microphone is inserted into the shield body through said apex central opening and being circumferentially spaced away from the interior wall surface of the shield, the interior wall surface of the shield having a sound absorbing surface material thereon, and the exterior wall of the shield having a sound reflecting surface material.
